(19) United States
(12) Patent Application Publication
(10) Pub. No.: US 2011/0022809 A1
(43) Pub. Date: Jan. 27, 2011

(54) CONSOLIDATED ELECTRONIC CONTROL UNIT AND RELAY PROGRAM IMPLEMENTED IN THE SAME

(75) Inventors: Yohsuke SATOH, Kariya-shi (JP); Akihito Iwai, Chiryu-shi (JP)

Correspondence Address: NIXON & VANDERHYE, PC, 901 NORTH GLEBE ROAD, 11TH FLOOR, ARLINGTON, VA, 22203, US

(73) Assignee: DENSO CORPORATION, Kariya-city (JP)

(21) Appl. No.: 12/844,083

(22) Filed: Jul. 27, 2010

(30) Foreign Application Priority Data
Jul. 27, 2009 (JP) 2009-174421

(51) Int. Cl. G06F 12/00

(52) U.S. Cl. 711/155; 711/E12.001

(57) ABSTRACT

In a consolidated electronic control unit (ECU) integrally produced by a plurality of conventional ECUs, an inventive relay program is adapted to enable a CPU of the consolidated ECU to rewrite internal and external parameters into the external and internal parameters, respectively, with reference to a correspondence list previously set between the internal parameter and the external parameter. The internal parameter is a parameter that is to be used by a specific program implemented in the consolidated ECU. The external parameter is a parameter that corresponds to the internal parameter and that is to be used by a non specific program implemented in the consolidated ECU.

### CROSS REFERENCE TO RELATED APPLICATIONS

This application is based on and claims the benefit of priority from earlier Japanese Patent Application No. 2009-174421 filed Jul. 27, 2009, the description of which is incorporated herein by reference.

### BACKGROUND OF THE INVENTION

1. Technical Field of the Invention

The present invention relates to a relay program for relaying a parameter inputted/outputted by a specific program, and a consolidated electronic control unit (ECU) implementing the relay program.

2. Related Art

A known technique to make it possible to develop software programs with less workload is disclosed in Japanese Unexamined Patent Application Publication No. 2003-150321. This technique splits the programs into a platform and components (e.g. application programs) and arranges them in a hierarchical structure to enable the components to utilize functions of the platform.

In recent years, it has been desired to make it possible to perform a plurality of processes that have been implemented in respective microcomputers on one microcomputer. When performing the plurality of application programs on one microcomputer, the application programs are required to be rewritten (or modified) taking account of connectivity with other application programs or hardware. Therefore, even validated application programs need to be validated again, which may increase workload.

Even when a design of program configuration is changed, e.g. when other application programs are added, rewriting of validated application programs and further validation of the rewritten programs will be needed, which may also increase workload.

### SUMMARY OF THE INVENTION

The present invention has been made in consideration of the foregoing difficulties, and it is an object of the present invention to provide a technique by which further validation of validated components can be eliminated, even when a plurality of components such as application programs that have been implemented in respective microcomputers are desired to be implemented on one microcomputer, or even when a design of program configuration has been changed.

According to one embodiment, there is provided a relay program for enabling a computer to relay a parameter inputted/outputted by a first program when the first program is performed between the first program and a second program other than the first program, the first program being implemented and specified as a specific program in a consolidated (or integrated, or unified) electronic control unit (ECU) integrally produced by a plurality of ECUs, the second program being implemented in the consolidated ECU, the relay program having been entitled to make the computer operate to have functions of: acquisition means for acquiring either an internal parameter or an external parameter, the internal parameter being a parameter that is to be used by the first program, the external parameter being a parameter that corresponds to the internal parameter and that is to be used by the second program; and rewriting means for rewriting the internal and external parameters into the external and internal parameters, respectively, with reference to a correspondence list previously set between the internal parameter and the external parameter.

For example, even if a destination address of the internal parameter changes after the whole specific program has been produced (for example by a programmer), the relay program can rewrite the destination address into a corresponding external parameter indicating an appropriate destination address with reference to the correspondence list, without rewriting the specific program. In addition, even if a value of the internal parameter becomes invalid for the other programs due to a design change of the program configuration, the relay program can rewrite the internal parameter into a corresponding external parameter indicating an appropriate value available for the other programs with reference to the correspondence list, and can output the corresponding external parameter.

In other words, further validation of validated components can be eliminated by the relay program, even when a plurality of components such as application programs that have been implemented in respective microcomputers need to be implemented on one microcomputer, or even when a design of program configuration has been changed.

According to one embodiment, there is provided an electronic control unit (ECU) comprising: a CPU; and relay means for enabling the CPU to relay a parameter inputted/outputted by a first program when the first program is performed between the first program and a second program other than the first program, the first program being implemented and specified as a specific program in the electronic control unit, the second program being implemented in the electronic control unit, the relay means is adapted to: receive either an internal parameter or an external parameter, the internal parameter being a parameter that is to be used by the first program, the external parameter being a parameter that corresponds to the internal parameter and that is to be used by the second program; and rewrite the internal and external parameters into the external and internal parameters, respectively, with reference to a correspondence list previously set between the internal parameter and the external parameter.

The aforementioned inventive electronic control unit can provide similar advantages to the relay program described above.

### BRIEF DESCRIPTION OF THE DRAWINGS

In the accompanying drawings:

FIG. 1A shows a block diagram of a consolidated ECU in accordance with one embodiment of the present invention;

FIG. 1B shows a block diagram of a consolidated control program in accordance with one embodiment of the present invention;

FIG. 2 shows a block diagram illustrating the virtual device and other components in accordance with one embodiment of the present invention;

FIG. 3 shows a sequence diagram illustrating operations during data transmission via the CAN in accordance with one embodiment of the present invention;

FIG. 4 shows a sequence diagram illustrating operations during data reception via the CAN in accordance with one embodiment of the present invention;

FIG. 5 shows a sequence diagram illustrating operations when the first CAN driver transmits reset instructions;

FIG. 6A shows a correspondence table of reset levels and reset targets in accordance with one embodiment of the present invention;

FIG. 6B shows a device-management table in accordance with one embodiment of the present invention;

FIG. 7 is a flow chart of a resetting process in accordance with one embodiment of the present invention;

FIG. 8A shows a VM-scheduling table in accordance with one embodiment of the present invention;

FIG. 8B shows a schedule-parameter table in accordance with one embodiment of the present invention;

FIG. 9 shows a timeslot-management table in accordance with one embodiment of the present invention;

FIG. 10 shows a flow chart of a timeslot allocating process in accordance with one embodiment of the present invention;

FIG. 11 shows a flow chart of a sub task initiating process in accordance with one embodiment of the present invention;

FIG. 12 shows a flow chart of an interrupting process in accordance with one embodiment of the present invention;

FIG. 13 shows a status of timeslot utilization in accordance to with one embodiment of the present invention; and

FIG. 14 shows a status of interrupting process execution in accordance with one embodiment of the present invention.

### DETAILED DESCRIPTION OF THE PREFERRED EMBODIMENTS

In the following the present invention will be described by means of exemplary embodiments in connection with the accompanying drawings.

### [Configuration]

### (1) Configuration of the Consolidated ECU

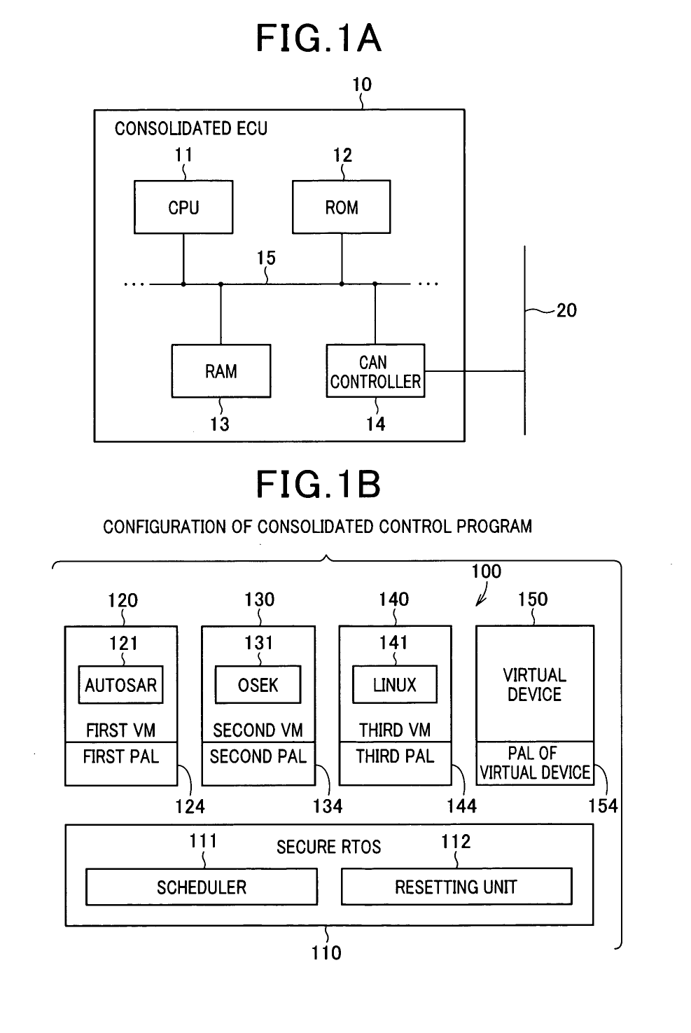

FIG. 1A is a block diagram that schematically illustrates a consolidated electronic control unit (ECU) 10 according to an embodiment of the present invention. The consolidated ECU 10 consolidates a first ECU, a second ECU, and a third ECU. The consolidated ECU 10 includes a CPU (or processor) 11, a ROM 12, a RAM 13, and a Controller Area Network (CAN) controller 14, which are connected with each other via an internal bus 15. It should be noted that in addition to these components, the consolidated ECU 10 may include other similar components (not shown) of each of the first to third ECUs.

The CPU 11 is responsible to run programs stored in the ROM 12 or programs loaded into the RAM 13 to control the consolidated ECU 10 or to perform other various operations. All the operations having been performed by respective CPUs of the first to third ECUs until the consolidation are to be performed by the CPU 11 of the consolidated ECU 10.

The ROM 12 may be well-known ROM having various programs and data stored therein. The RAM 13 may be used as a main memory to be directly accessed by the CPU 11. The various programs and data may be loaded from the ROM 12 into the RAM 13.

The CAN controller 14 is responsible to communicate with other ECUs via the CAN 20.

### (2) Configuration of the Consolidated Control Program

FIG. 1B is a block diagram that schematically illustrates configuration of a consolidated control program 100 residing in the consolidated ECU 10. The consolidated control program 100 is stored in the ROM 12. The consolidated control program 100 includes a secure real time operating system (RTOS) 110, a first virtual machine (VM) 120, a second VM 130, a third VM 140, and a virtual device 150. The consolidated control program 100 further includes a first Physical Abstraction Layer (PAL) 124, a second PAL 134, a third PAL 144, and a virtual device's PAL 154 associated with VM 120, VM 130, VM 140, and the virtual device 150, respectively.

The secure RTOS 110 is a program that performs scheduling of tasks such as the first to third VMs 120-140 and the virtual device 150. The scheduling is to be performed by a scheduler 111, as will be elaborated later. It should be noted that the secure RTOS 110 may secure (or protect) its own associated memory region and a memory region associated with each of the tasks.

The secure RTOS 110 further includes a resetting unit 112. The resetting unit 112 is operative to identify a device (or devices) to be reset in accordance with a specified reset range received from each of VMs 120-140, and to transmit a reset instruction (or reset instructions) toward the device (s) to be reset.

The first to third VMs 120-140 are tasks to be scheduled by the secure RTOS 110. Each of these VMs is a program obtained by partially modifying its corresponding control program prior to the consolidation. For example, the first VM is a program obtained by partially modifying the control program of the first ECU.

It should be noted that since the first ECU and the second ECU are both required to respond to an external input in real time within a predetermined period, the first VM 120 and the second VM 130 are required to perform a real time process. The first ECU implements a RTOS compliant with AUTOSAR®, and the second ECU implements a RTOS compliant with OSEK®. Accordingly, the first VM 120 implements the RTOS compliant with AUTOSAR, and the second VM 130 implements the RTOS compliant with OSEK.

Hereinafter, a RTOS used in the VM 120 will be denoted by AUTOSAR 121, and a RTOS used in the VM 130 will be denoted by OSEK 131. On the other hand, the third ECU (prior to the consolidation) doesn't require any real time process. Accordingly, the third VM doesn't require any real time process either. The third ECU employs Linux, so the third VM 140 implements Linux 141.

Each of the first to third VMs 120-140 has an interrupting process corresponding to an interrupt handler that has been used in a program residing in the corresponding ECU prior to the consolidation. The secure RTOS 110 performs said corresponding interrupting process on occurrence of an interrupt request from a peripheral device.

The virtual device 150 performs an I/F task between the first to third VMs and peripheral devices of the CPU 11 that is in the consolidated ECU 10.

On the other hand, the PALs 124, 134, 144, 154 are provided associated with the VM 120, 130, 140, and the virtual device 150 (which are referred to as “specific programs”), respectively. Each of the PALs 124, 134, 144, 154 acts as a relay program of the present invention (which may be previously stored in a memory such as ROM 12 and RAM 13, and may be accessed by the CPU 11 when the CPU 11 runs the relay program) to be performed by a computer when the computer relays a parameter that is inputted/outputted by its associated specific program when said associated specific program is performed, between said associated specific program and a non specific program.

Each of the PALs 124, 134, 144, 154 is operative to rewrite (or convert) a parameter to be used by its associated specific program (herein referred to as an “internal parameter”) into a parameter to be used by a non specific program (herein referred to as an “external parameter”) and vice versa, with reference to a list which associates the internal parameter with the external parameter. The non specific program is a program other than (or different from) all the specific program(s) and corresponds to the second program of the present invention.

The above functions will be explained later.

### [Operations]

The consolidated control program 100 provides functions of the first to third ECUs. In the consolidated control program 100, in order to provide the functions of the first to third ECUs, the secure RTOS 110 performs scheduling of the first to third VMs such that the first to third VMs are concurrently performed by the CPU 11.

### (1-1) Virtual Device

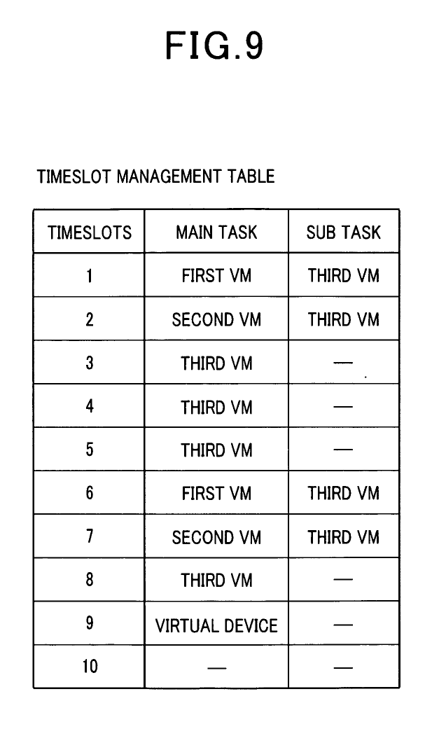

There will now be explained the virtual device 150 that is as one of tasks of the scheduler 111. As described above, the virtual device 150 is an I/F (interface) portion between the first to third VMs and peripheral devices of the CPU 11, Also, the virtual device 150 is listed in the timeslot management table of FIG. 9 as a main task to be allocated a timeslot 9, which will be described later. As an example, there will now be explained a function of the virtual device 150 corresponding to the CAN controller 14.

The first ECU and the second ECU may communicate in compliance with the CAN protocol. The programs of these ECUs include a CAN driver to control the CAN communications. The CAN driver conducts I/O access to a register in order to control the CAN controller in the ECU prior to the consolidation. The first VM 120 and the second VM 130 include a first CAN driver 122 and a second CAN driver 132, respectively. These CAN drivers have been used in the respective ECUs. The virtual device 150 is operative to receive an instruction from the first CAN driver 122 or the second CAN driver 132 to the CAN controller 14 to control the CAN controller 14.

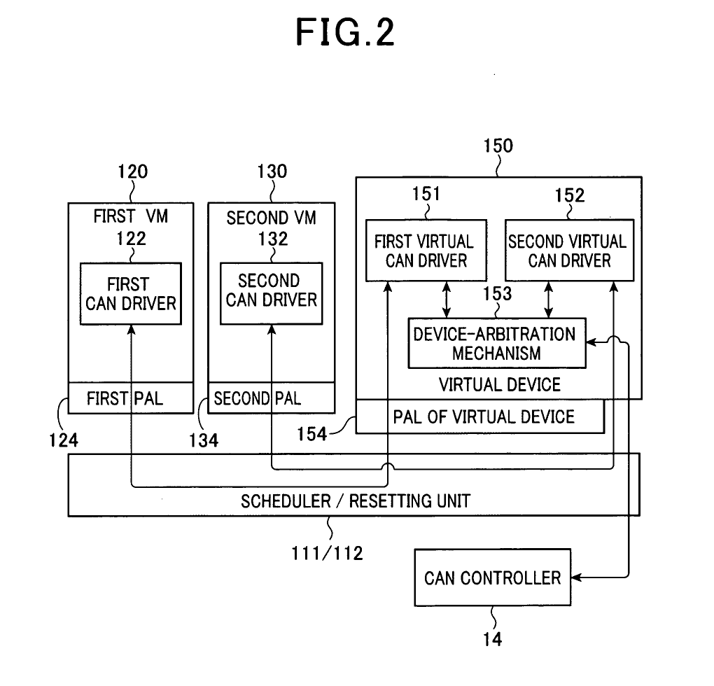

There will now be explained configuration of the virtual device 150 with reference to a block diagram illustrated in FIG. 2. The virtual device 150 includes a first virtual CAN driver 151, a second virtual CAN driver 152, and a device-arbitration mechanism 153.

The first virtual CAN driver 151 is operative to receive an instruction from the first CAN driver 122 to the CAN controller 14 via the first PAL 124 and the virtual device's PAL 154 when the first VM 120 wishes to communicate with other ECUs via the CAN 20.

On the other hand, the second virtual CAN driver 152 is operative to receive an instruction from the second CAN driver 132 to the CAN controller 14 via the second PAL 134 and the virtual device's PAL 154 when the second VM 130 wishes to communicate with other ECUs via the CAN 20.

The device-arbitration mechanism 153 is responsible to control the CAN controller in accordance with instructions from the first CAN driver 122 and the second CAN driver 132.

### (1-2) Operations During Data Transmission

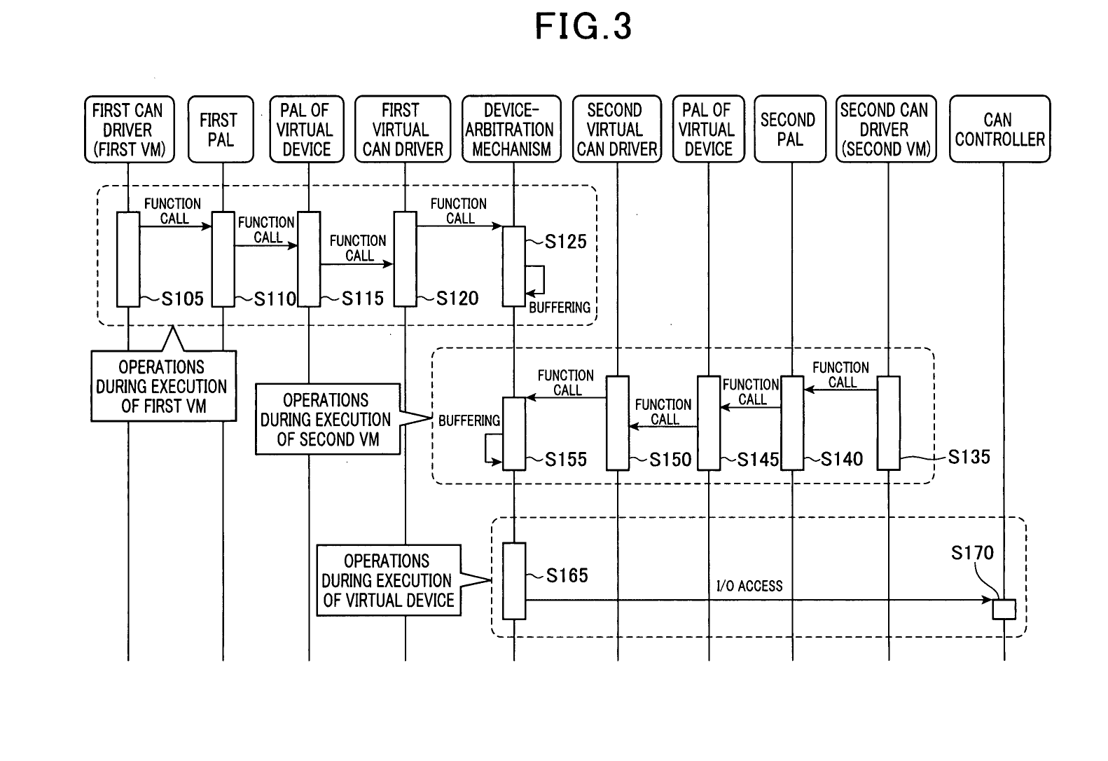

There will now be explained operations during data transmission from the first VM 120 or the second VM 130 to other ECUs connected to the consolidated ECU 10 via the CAN 20, along with operations of each of the PALs 124, 134, 154, with reference to a sequence diagram illustrated in FIG. 3.

When the first VM 120 wishes to transmit data via the CAN 20, the first VM 120 calls the first CAN driver 122 (at step S105).

The first CAN driver 122 requests for transmission of data via the CAN 20 and then sets up its transmit data, in a manner adapted to the CAN controller that is a peripheral device of the first ECU's CPU. The request for data transmission may include designation of an address of the first CAN driver. However, when the system configuration is modified or changed (e.g. when a further VM is added to the system), the address of the first CAN driver may be modified or changed.

The request for data transmission is transmitted via the PALs for programs related to the first CAN driver 122 (in the first VM 120) not to have to be rewritten or modified. In other words, the first PAL 124 rewrites the destination address of the data transmission request from the first CAN driver 122 (the internal parameter) into the address adapted to the whole system configuration including the scheduler 111 and the resetting unit 112 (the external parameter) (at step S110).

The PAL 154 associated with the virtual device 150 then rewrites the address rewritten by the first PAL 124 (the external parameter) into the address adapted to the virtual device 150 (the internal parameter) (at step S115).

Then, the first virtual CAN driver 151 in the virtual device 150 is called from the first CAN driver 122 as a subroutine by the first virtual CAN driver 151 receiving the data from the PAL 154 of the virtual device 150 (at step S120). It should be noted that a relation between internal parameters and external parameters of each PAL is previously stored (as a correspondence list) in the ROM 12 or the RAM 13.

In this way, the first virtual CAN driver 151 receives the request for data transmission via the CAN 20, in a manner adapted to the CAN controller in the first ECU. As a result, changes to the system when using a program having used in the first ECU for the first CAN driver 122 can be minimized.

The virtual CAN driver 151 may also be configured to respond to the first CAN driver 122, as done in the CAN controller in the first ECU. This enables the first CAN driver 122 to transmit data via the CAN 20 in the same way as the first ECU. Therefore, changes to the system when using a program having used in the first ECU for the first CAN driver can be minimized.

Then, the first virtual CAN driver 151 calls a subroutine belonging to the device-arbitration mechanism 153 (at step S125). This subroutine includes buffering the transmit data received from the first CAN driver 122.

Similarly, when the second VM 130 wishes to transmit data via the CAN 20, the second VM 130 calls the second CAN driver 132 (at step S135).

Then, the second PAL 134 rewrites the destination address of the data transmission request from the second CAN driver 132 (the internal parameter) into the address adapted to the whole system configuration including the scheduler 111 and the resetting unit 112 (the external parameter) (at step S140).

The PAL 154 in the virtual device 150 then rewrites the address rewritten by the second PAL 134 (the external parameter) into the address adapted to the virtual device 150 (the internal parameter) (at step S145).

Then, the second virtual CAN driver 152 in the virtual device 150 will be called from the second CAN driver 132 as a subroutine by the second virtual CAN driver 152 receiving the data from the PAL 154 of the virtual device 150 (at step S150).

In this way, the second virtual CAN driver 152 receives the request for data transmission via the CAN 20, in a manner adapted to the CAN controller in the second ECU. The second virtual CAN driver 152 may also be configured to respond to the second CAN driver 132, as in the CAN controller in the second ECU.

Then, the second virtual CAN driver 152 calls a subroutine belonging to the device-arbitration mechanism 153 (at step S155). This subroutine includes buffering the transmit data received from the second CAN driver 132.

Then, a predetermined timeslot (timeslot 9 in FIG. 9) is allocated to the virtual device 150. When the virtual device 150 is triggered to operate, a subroutine belonging to the device-arbitration mechanism 153 is called (at step S165). This subroutine instructs the CAN controller 14 to transmit the data received from the first CAN driver 122 in a manner adapted to the CAN controller 14. Specifically, the subroutine performs I/O access to the CAN controller (at step S170), and sets up the buffered transmit data in the transmit buffer of the CAN controller, and then instructs the CAN controller to transmit the data.

### (1-3) Operations During Data Reception

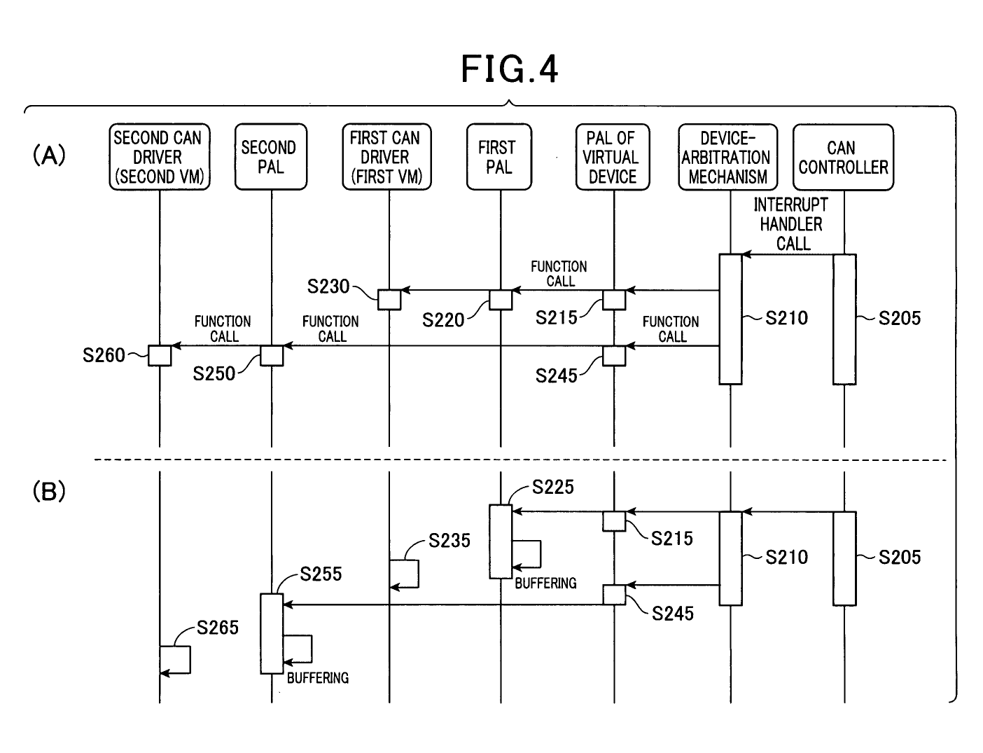

There will now be explained operations of the virtual device 150 during data reception from other ECUs connected to the consolidated ECU 10 via the CAN 20, with reference to an upper sequence diagram illustrated in FIG. 4.

When the consolidated ECU 10 receives data from other ECUs via the CAN 20, the CAN controller 14 sends an interrupt request to the CPU 11 (at step S205), and then the interrupt handler corresponding to the interrupt request (which is also referred to as a “CAN receive interrupt handler”) is called (at step S210). It should be noted that the CAN receive interrupt handler belongs to the device-arbitration mechanism 153 in the virtual device 150.

The CAN receive interrupt handler acquires the received data from the CAN controller 14. If the destination of the received data is the first VM 120, a subroutine belonging to the first CAN driver 122 is called (at step S230) via the virtual device's PAL 154 and the first PAL 124 (at steps S215, S220), as described above. The subroutine sets a CAN receive interrupt request flag for the first VM 120 to inform the first VM 120 of the data reception and to buffer the received data in the first VM 120, in a similar way to the procedure performed by the CAN controller in the first ECU.

On the other hand, if the destination of the received data is the second VM 130, a subroutine belonging to the second CAN driver 132 is called (at step S260) via the virtual device's PAL 154 and the second PAL 134 (at steps S245, S250). This subroutine also sets a CAN receive interrupt request flag for the second VM 130 to inform the second VM 130 of the data reception and to buffer the received data in the second VM 130, in a similar way to the procedure performed by the CAN controller in the second ECU.

It should be noted that in the above operations during data reception the received data may be buffered in the PAL that receives and relays the received data (the first PAL 124 or the second PAL 134 in the present embodiment). In other words, as shown in a lower sequence diagram (B) illustrated in FIG. 4, the first PAL 124 and the second PAL 134 may be operative to buffer the received data (at steps S225, S255) to enable the first CAN driver 122 or the second CAN driver 132 to acquire the buffered data whenever the first CAN driver 122 or the second CAN driver 132 initiates its process.

### (1-4) Operations During Resetting Process

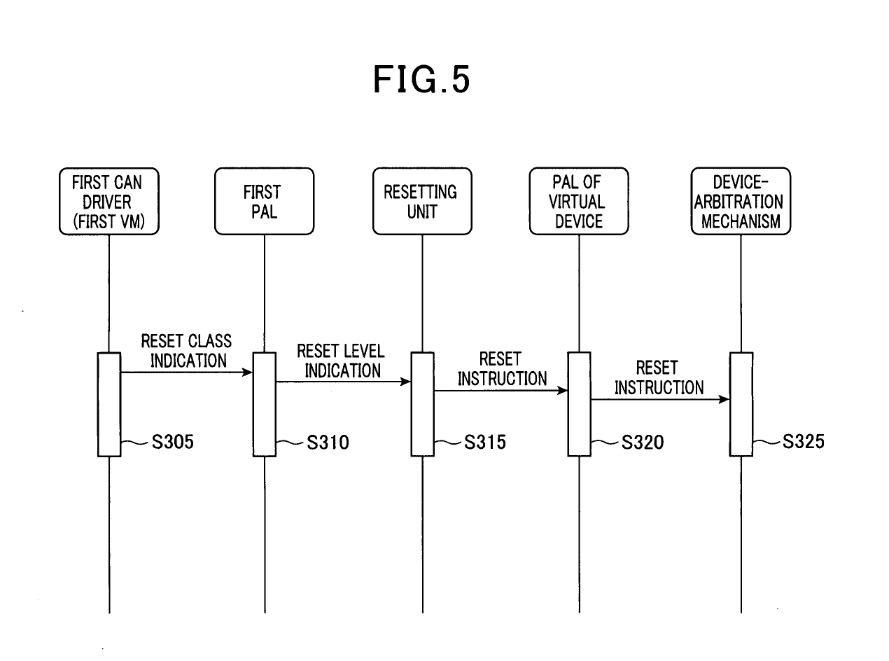

Each CAN driver 122, 132 has a function for sending various commands such as a reset instruction to other programs such as the virtual device 150, and to other devices such as the CAN controller 14. FIG. 5 shows a sequence diagram illustrating operations performed when the first CAN driver 122 sends the reset instructions to various portions of the consolidated ECU 10.

At first, if the first CAN driver 122 determines to reset, the first CAN driver 122 designates a reset class, and outputs its corresponding reset instruction (the internal parameter) (at step S305). The first CAN driver 122 detects various statuses such as a communication status in the CAN controller and an internal communication status via the first PAL 124, and selects a reset range based on the detection result.

In particular, reset ranges may include a soft reset and a physical reset that has a wider range than the soft reset.

The first PAL 124 is operative to rewrite the instruction of the reset range designated by the first CAN driver 122 into a common parameter that can be recognized by the resetting unit 112 and the other PALs 134, 154. Specifically, if the instruction of the reset range is the soft reset, the first PAL 124 designates the reset level 2, and if the instruction of the reset range is the physical reset, the first PAL 124 designates the reset level 0.

It should be noted that the second CAN driver 132 may also designate a reset class and may output a reset instruction (the internal parameter). In the present embodiment, the second PAL 134 may be operative to designate the reset level 1 if the second CAN driver 132 designates the soft reset, and may be operative to designate the reset level 0 if the second CAN driver 132 designates the physical reset.

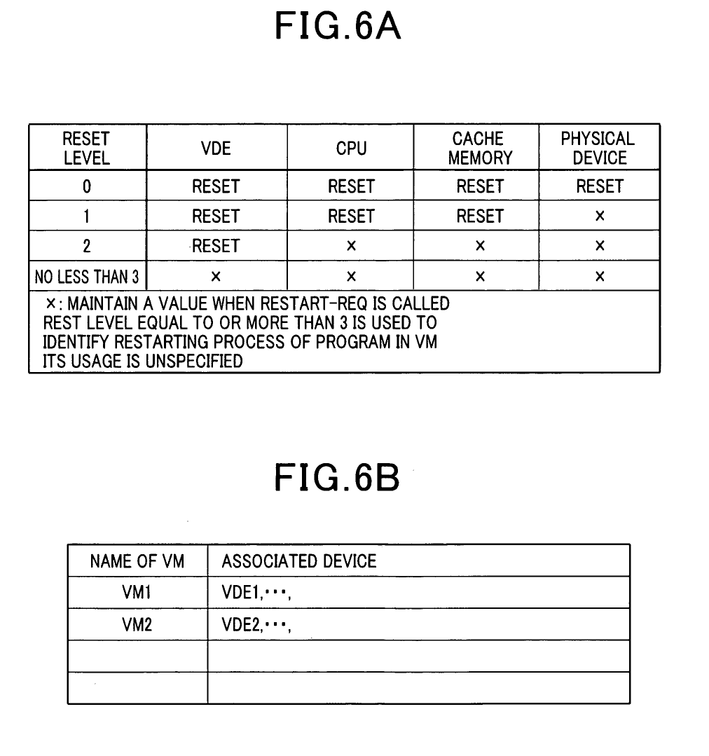

The resetting unit 112 performs, in response to the reset level, a corresponding resetting process (which will be described later) and sends reset instructions to reset targets successively (at step S315). It should be noted that a correspondence table between the reset levels and the reset targets may be previously stored in the ROM 12, as shown in FIG. 6A. The term “reset targets” means targets to be reset.

Specifically, reset targets at the reset level 0 are the virtual CAN drivers 151, 152 (VDE), CPUs of the target VMs (particularly, timers such as interval timers included in the CPUs), cache memories of the target CPUs, and the CAN controller 14 (a physical device), which are all to be reset. Reset targets at the reset level 1 are the virtual CAN drivers 151, 152 (VDE), CPUs of the target VMs, cache memories of the target CPUs. All of them are also to be reset.

On the other hand, reset targets at the reset level 2 are only VDEs. It should be noted that reset targets at the reset levels equal to or higher than 3 are optional, so a user can arbitrarily define a reset range for such a reset level. Each VM is associated with a virtual CAN driver, as illustrated in the device-management table of FIG. 6B. The device-management table may be previously stored in the ROM 12. Specifically, the first VM 120 (VM1) is associated with the first virtual CAN driver 151 (VDE 1), and the second VM 130 (VM 2) is associated with the second virtual CAN driver 152 (VDE 2).

During a resetting process, only the source VM of the reset instruction (i.e. the VM from which the reset instruction originated) may be a reset target. Then only functions associated with this VM may constitute a reset range. In other words, even in the consolidated ECU 10, an ECU prior to the consolidation may be a resetting unit (i.e. a unit per which a resetting process is performed).

Then the PAL 154 of the virtual device 150 rewrites a destination address of a reset instruction into an address adapted to the virtual device 150, and then sends the rewritten address to the virtual device 150 (in particular, the device-arbitration mechanism 153) (at step S320), where the reset target will be reset (at step S325).

It should be noted that optionally only a buffering process may be performed at step S320, as is exemplary shown at step S225 in a lower sequence diagram (B) of FIG. 4, and that the device-arbitration mechanism 153 may be operative to acquire the buffered data.

### (1-5) Resetting Process

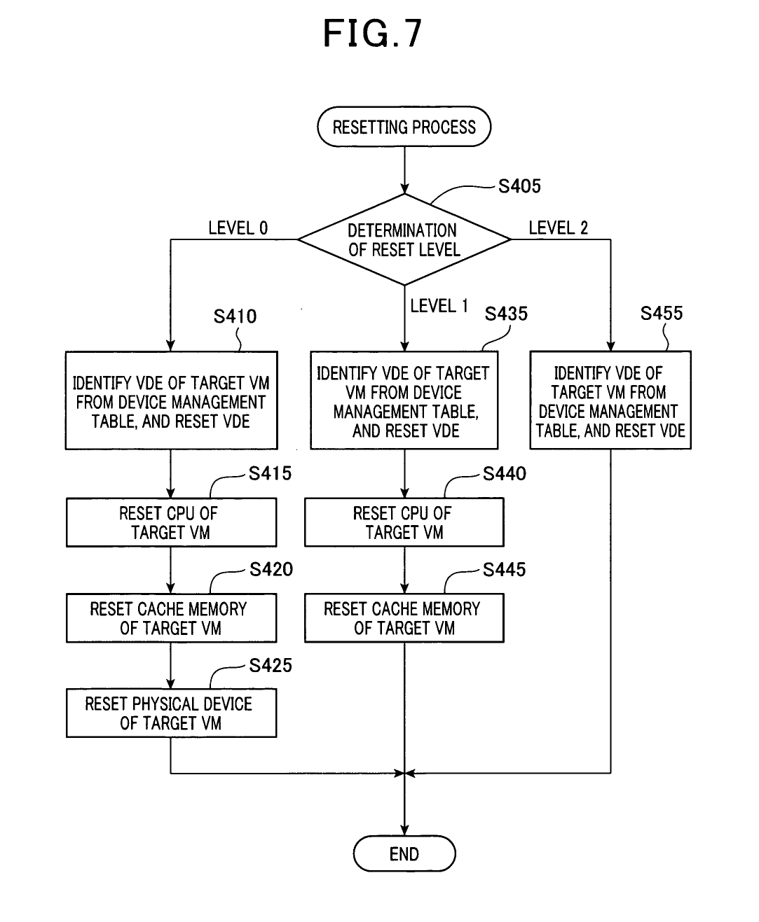

There will now be explained a process performed when the CPU 11 implements the function of the resetting unit 112, with reference to FIG. 7. FIG. 7 shows a flow chart illustrating the resetting process performed by the CPU 11.

The resetting process starts with inputting of a reset instruction, and is performed during execution of the source VM of the reset instruction. Specifically, as shown in FIG. 7, the reset level is determined (at step S405). If the reset level is 0 (i.e. if 0 is selected at step S405), a virtual CAN driver associated with the target VM (i.e. the source VM of the reset instruction) is identified from the device-management table as illustrated in FIG. 6B, and then the reset instruction is sent to the identified virtual CAN driver (at step S410). The reset instruction is then sent to the CPU of the target VM (at step S420). And then the reset instruction is sent to a cache memory of the target CPU (at step S430).

Finally, the reset instruction is sent to the target physical device (the CAN controller 14 in the present embodiment). This resetting process ends with completion of this step.

Next, if the reset level is 1 (“1” at step S405), steps S435-S445 are performed. In these steps, a similar process to steps S410-S425 may be performed.

If the reset level is 2 (“2” at step S405), step S455 is performed, where only a similar process to step S410 may be performed.

### (2) Operations of the Secure RTOS 110

There will now be explained operations performed by the secure RTOS 110.

### (2-1) Timeslots

The scheduler 111 of the secure RTOS 110 is responsible for tasks such as the first to third VMs and the virtual device 150, and is operative to allocate timeslots 1-10 to these tasks one by one in ascending order. After the allocation of the timeslot 10, the timeslots 1-10 will be again allocated to the tasks from the timeslot 1. Once a given task is allocated one of the timeslots, the CPU 11 performs the given task during a processing time given by duration of the allocated timeslot.

In the present embodiment, the timeslots 1-10 are all of length of 100 μs. But a length of each of the timeslots is not limited to 100 μs. For example, a timeslot length may vary with a task to be allocated the timeslot, or may vary with a given requirement or condition. In some embodiments, a certain range of timeslot length (e.g. 100-120 μs) may be used. The runtime of the CPU may vary within this range of timeslot length depending on a given requirement or condition or a task status.

It should be noted that the allocation of a given timeslot to a task may be regarded as assignment of execution right of the CPU to this task during this given timeslot.

### (2-2) Scheduling the First to Third VMs

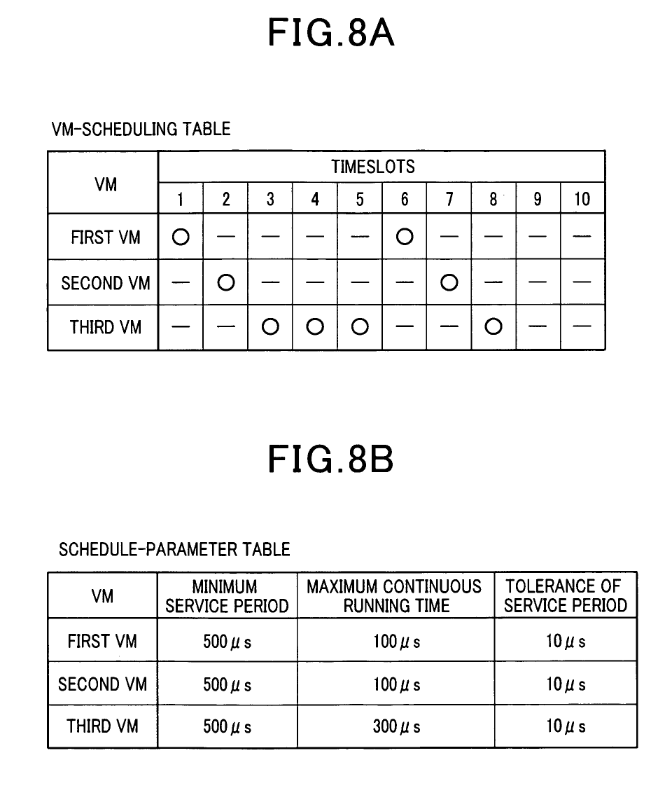

There will now be explained scheduling the first to third VMs. FIG. 8A is a VM-scheduling table indicating how to allocate the timeslots 1-10 to the first to third VMs. FIG. 8B is a scheduling-parameter table including service periods of the first to third VMs.

As shown in FIG. 8A, the VM-scheduling table shows that the timeslot 1 is to be allocated to the first VM 120, the timeslot 2 to the second VM 130, the timeslot 3 to the third VM 140 (not shown), the timeslot 4 to the third VM 140, the timeslot 5 to the third VM 140, the timeslot 6 to the first VM 120, the timeslot 7 to the second VM 130, and the timeslot 8 to the third VM 140.

The VM-scheduling table shows that the timeslots 9, 10 are to be allocated to none of the first to third VMs. The VM-scheduling table also shows that the scheduler 111 is adapted to allocate the timeslots 1-10 to the first to third VMs, and to instruct the CPU 11 to run the first to third VMs in parallel.

As shown in FIG. 8B, the schedule-parameter table includes the items such as “VM”, “MINIMUM SERVICE PERIOD”, “MAXIMUM CONTINUOUS RUNNING TIME”, and “TOLERANCE OF SERVICE PERIOD.”

Specifically, the item “VM” indicates one of the first to third VMs. The item “MINIMUM SERVICE PERIOD” defines a time interval at which a given VM is allocated one of the timeslots. The item “MAXIMUM CONTINUOUS RUNNING TIME” defines a maximum continuous running time of the given VM. The item “TOLERANCE OF SERVICE PERIOD” defines a tolerance of the minimum service period of the given VM.

The secure RTOS 110 may be configured to detect an anomaly based on the schedule-parameter table, regarding the scheduling of the first to third VMs by the scheduler 111. There will now be explained in more detail such a function. The secure RTOS 110 defines, for each VM, a threshold time period given by a sum of a corresponding time value of the “MINIMUM SERVICE PERIOD” and a corresponding time value of the “TOLERANCE OF SERVICE PERIOD.” If none of the timeslots (the timeslots 140 in the present embodiment) has been allocated to a given real time VM the is threshold time period after the allocation of the last timeslot to the given real time VM, the secure RTOS 110 determines that there has been some anomaly. Also, for each VM, if the CPU 11 is still running even after a corresponding time value of the “MAXIMUM CONTINUOUS RUNNING TIME” has elapsed after the allocation of the last timeslot to the VM, the secure RTOS 110 determines that there has been some anomaly.

### (2-3) Task Scheduling

There will now be explained the task scheduling of the scheduler 111. In principle, as described above, the timeslots 1-10 are each to be allocated to one of the first to third VMs in ascending order (i.e. from the timeslot 1). However, the virtual device 150 also has to be provided with a certain amount of processing time. Therefore, some of the timeslots may be allocated to the virtual device 150.

The first VM 120 and the second VM 130 having been allocated timeslots may voluntarily terminate their own processes once a certain condition has been met. Thus, the first VM 120 and the second VM 130 may terminate their own processes before expiration of their own allocated timeslots. Supposing that such a case may happen, a main task may be associated with a sub task for each of the timeslots 1-10. If a main task terminates before expiration of the timeslot allocated the main task, the scheduler 111 may allocate a remaining time of the timeslot to the associated sub task.

The VM-scheduling table as shown in FIG. 8A shows that the VMs have entered the table as main tasks for the timeslots 1-10.

### (3-1) Timeslot Management Table

FIG. 9 shows an example of the timeslot management table in which some of the timeslots are each associated with a main task and a sub task. The exemplary timeslot management table shows that the timeslots 1, 6 are associated with the first VM 120 as a main task and the third VM 140 as a sub task.

The timeslot management table further shows that the timeslots 2, 7 are associated with the second VM 130 as a main task and the third VM 140 as a sub task. The timeslot management table still further shows that the timeslots 3-5 and 8 are associated with the third VM 140 as a main task and nothing as a sub task.

The timeslot management table yet still further shows that the timeslot 9 is associated with the virtual device 150 as a main task and nothing as a sub task. Furthermore, it is shown that the timeslot 10 is associated with nothing as a main task and nothing as a sub task. The scheduler 111 may be configured to schedule each task based on the timeslot management table.

### (3-2) Timeslot Allocating Process

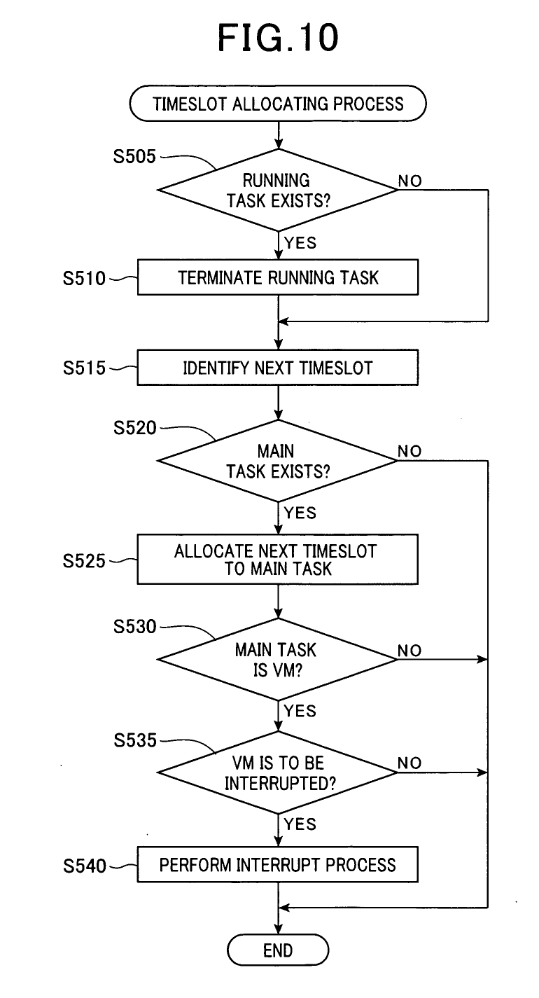

There will now be explained in more detail the task scheduling of the scheduler 111. The scheduler 111 performs the timeslot allocation every time a duration of one timeslot (100 μs) has elapsed. The timeslot allocation will be explained in the following with reference to a flow chart illustrated in FIG. 10.

At step S505, the scheduler 111 checks whether or not there exists any running task (or any task assigned a CPU execution right) If such a running task exists (“YES” at step S550), the scheduler 111 terminates the task (at step S510).

Then, the scheduler 111 identifies a timeslot to be allocated to a task (i.e. a next timeslot) based on the timeslot management table (at step S515). It should be noted that the scheduler 111 allocates a timeslot with a smaller number to its corresponding task. (That is, in the present embodiment, the scheduler 111 is configured to allocate the timeslots 1-10 to tasks in numerical order.) After the last timeslot 10 is allocated to its corresponding task (no task in the present embodiment), the timeslots 1-10 are again allocated from the timeslot 1.

The scheduler 111 then detects whether or not there exists any main task to be allocated the identified timeslot with reference to the timeslot management table (at step S520). If such a main task exists (“YES” at step S520), the scheduler 111 allocates the identified timeslot as the next timeslot (like the timeslots 1-9 in the present embodiment) to the main task (at step S525). If there is no main task to be allocated the identified timeslot as the next timeslot like the timeslot 10 (“NO” at step S520), the scheduler 111 terminates the timeslot allocating process without allocating the identified timeslot.

Then, if the detected main task allocated the identified timeslot as the next timeslot is one of the VMs (“YES” at step S530), the scheduler 111 checks whether or not the interrupt request flag corresponding to the main task is set (at step S535). If the flag is set (“YES” at step S535), the scheduler 111 instructs the CPU 11 to perform the interrupting process in this VM corresponding to this flag (at step S540). Once the interrupting process is completed, the scheduler 111 clears (or resets) the interrupt request flag, and then terminates the present timeslot allocating process. After that, in the VM allocated the identified timeslot, some process other than the interrupting process is performed.

If the main task allocated the identified timeslot as the next timeslot is none of the VMs (“NO” at step S530), or if the interrupt request flag corresponding to this main task is not set (“NO” at step S535), the scheduler 111 terminates the present timeslot allocating process. After that, the main task allocated the identified timeslot is performed.

It should be noted that the interrupting process in the present embodiment of the consolidated ECU 10 is not the interrupt handler directly called from the CPU 11 in response to an interrupt request from a peripheral device of the CPU 11, but a subroutine corresponding to the interrupt handler that has been used in the control program of the pre-consolidation ECU that corresponds to the a VM to be interrupted.

### (3-3) Sub Task Initiating Process

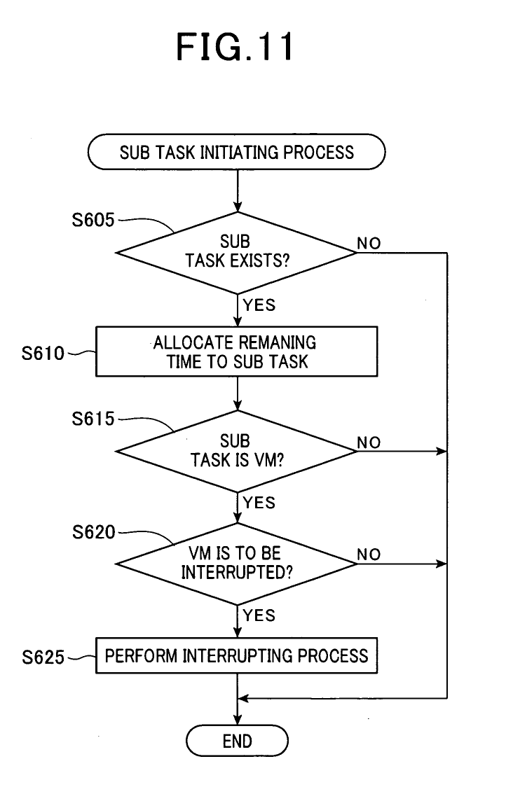

As described above, the first VM 120 and the second VM 130 may voluntarily terminate their own processes. Once a main task allocated a timeslot (one of the timeslots 1-10 in the present embodiment) voluntarily terminates, the scheduler 111 initiates a sub task associated with the main task. The initiating process of the sub task will now be explained with reference to a flow chart illustrated in FIG. 11.

At step S605, the scheduler 111 detects whether or not there exists any sub task registered with the timeslot allocated to the main task that has voluntarily terminated, with reference to the timeslot management table. If such a sub task exists as in the case of the timeslots 1, 2, 6, 7 (“YES” at step S605), the process proceeds to step S610. If there exists no such sub task (“NO” at step S605), the scheduler 111 terminates the present sub task initiating process.

At step S610, the scheduler 111 allocates a remaining time of the timeslot allocated to the main task that has voluntarily terminated to the registered sub task. Then, the process proceeds to step S615.

If the registered sub task is one of the VMs (“YES” at step S615), the scheduler 111 checks whether or not the interrupt request flag for the VM that is the registered sub task is set (at step S620). If this flag is set (“YES” at step S620), the scheduler 111 instructs the CPU 11 to perform the corresponding interrupting process in this VM (at step S625). Once this interrupting process is completed, the scheduler 111 clears (or resets) the interrupt request flag for this VM, and then terminates the present sub task initiating process. After that, some process other than the above interrupting process is to be performed in the VM that is the registered sub task.

If the registered sub task is none of the VMs (“NO” at step S615), or if the interrupt request flag for the VM that is the registered sub task is not set (“NO” at step S620), the scheduler 111 terminates is the present sub task initiating process. After that, the registered sub task that has been allocated the remaining time is to be performed.

### (3-4) Interrupting Process

As described above, the consolidated ECU 10 consolidates the first to third ECUs, and implements functions of these ECUs. The first to third VMs are partially modified programs of the first to third ECUs, respectively. While the programs of the first to third ECUs each implement an interrupt handler which is directly called from a CPU when a corresponding interrupt request is issued from a peripheral device of the CPU, the first to third VMs each implement a subroutine corresponding to this interrupt handler.

Once an interrupt request is issued (or generated) from a peripheral device of the CPU 11 to the CPU 11, the consolidated ECU 10 enables the interrupt handler to be performed. This interrupt handler is operative to inform the target VM of the issued interrupt request by identifying to which VM the issued interrupt request is directed and setting the interrupt request flag for the identified VM (i.e. the target VM).

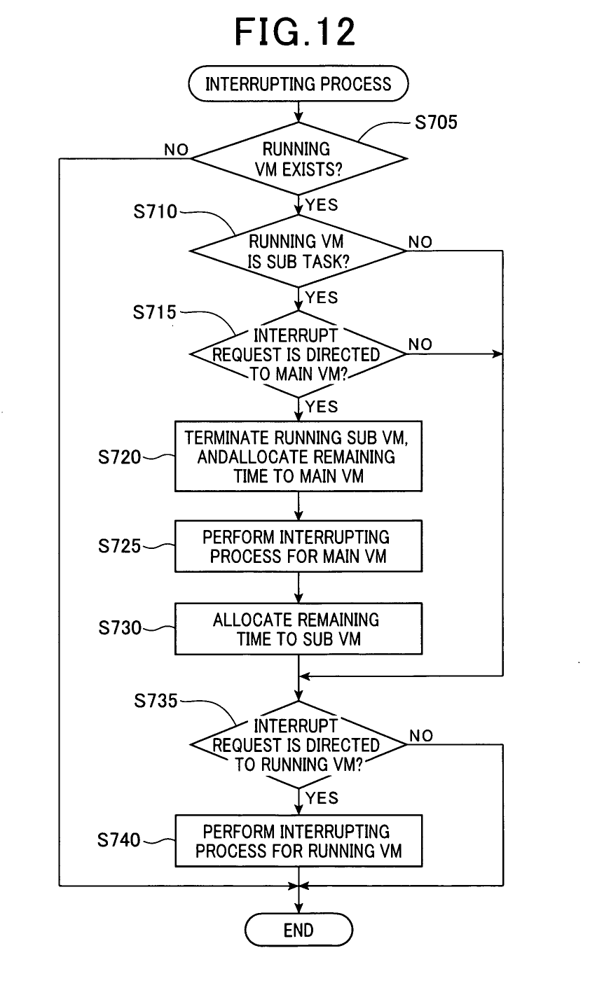

In the following, there will be explained an interrupting process to be performed by the scheduler 111 once an interrupt request is issued from a peripheral device of the CPU 11 and then the target VM is informed of the interrupt request, with reference to a flow chart illustrated in FIG. 12. A process to be performed in the consolidated control program 100 when an interrupt request is issued from a peripheral device of the CPU 11 to the CPU 11 will be explained later.

At step S705, the scheduler 111 determines whether or not one of the first to third VMs is presently being allocated a timeslot. If one of the first to third VMs is presently being allocated a timeslot (“YES” at step S705), the process proceeds to step S710. On the other hand, if none of the first to third VMs is presently being allocated a timeslot (“NO” at step S705), the scheduler 111 terminates the present interrupting process. In the following, a VM that is presently allocated a timeslot is also referred to as a “running VM.”

At step 710, the scheduler 111 determines whether or not the running VM has entered the timeslot management table as a sub task. (Hereinafter, a VM that has entered the timeslot management table as a main task is also referred to as a “main VM”, and a VM that has entered the timeslot management table as a sub task is also referred to as a “sub VM.”) If the running VM has entered the timeslot management table as a sub task (“YES” at step S710), the scheduler 111 determines whether or not the issued interrupt request is directed to a main VM associated with the running sub VM (at step S715). If the issued interrupt request is directed to the main VM associated with the running sub VM (“YES” at step S715), the scheduler 111 enables the process to proceed to step S720. If the running VM is not any sub VM (“NO” at step S710), or if the issued interrupt request is not directed to the main VM associated with the running sub VM (“NO” at step S715), the scheduler 111 enables the process to proceed to step S735.

At step S720, the scheduler 111 allocates a remaining time of the present timeslot to the main VM associated with the running sub VM in place of this running sub VM, and performs in this main VM an interrupting process corresponding to the issued interrupt request (at step S725). Once this interrupting process is completed, the scheduler 111 clears (or resets) the flag for this main VM, and allocates a remaining time of the present timeslot to the sub VM associated with this main VM in place of this main VM (at step S730), The scheduler 111 enables the process to proceed to step S735.

At step S735, the scheduler 111 determines whether or not the issued interrupt request is directed to the running VM. If the issued interrupt request is directed to the running VM (“YES” at step S735), the scheduler 111 performs the corresponding interrupting process in the running VM (at step S740). Once this interrupting process is completed, the scheduler 111 clears (or resets) the interrupt request flag for this running VM, and terminates the present interrupting process. If the issued interrupt request is not directed to the running VM (“NO” at step S735), the scheduler 111 terminates the present interrupting process.

### (4) Status of Timeslot Utilization

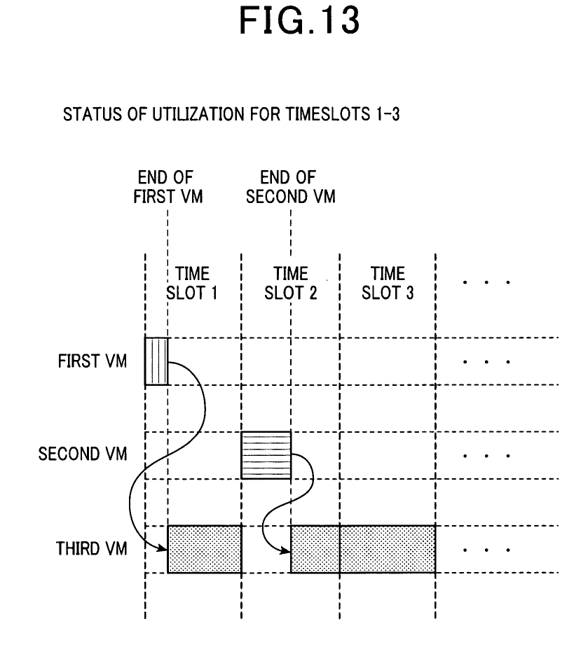

There will now be explained a status of timeslot utilization when allocating the timeslots during the above timeslot allocating process or during the above sub task initiating process. It is supposed that the scheduler 111 is configured to allocate the timeslots in accordance with the timeslot management table as illustrated in FIG. 9. For simplicity, in the following, the status of timeslot utilization for the timeslots 1-3 will be explained with reference to FIG. 13.

As shown in FIG. 13, the timeslot 1 is first allocated to the first VM 120 that is a main task for this timeslot. If the first VM 120 voluntarily terminates before 100 μs (a duration of the timeslot 1) elapses from the time of allocation of the timeslot 1 to the first VM, a remaining time of the timeslot 1 is allocated to the third VM 140 that is a sub task for this timeslot. On the other hand, if the first VM 120 doesn't voluntarily terminate during the timeslot 1, no remaining time of the timeslot 1 is allocated to the third VM 140. In such a case, the whole timeslot 1 is consumed only by the first VM 120.

Once the whole timeslot 1 has been consumed (in other words, once 100 μs has elapsed from the time of allocation of the timeslot 1 to the first VM 120), allocation of the timeslot 2 is then performed. The timeslot 2 is first allocated to the second VM 130 that is a main task for this timeslot. If the second VM 130 voluntarily terminates before 100 μs (a duration of the timeslot 2) elapses from the time of allocation of the timeslot 2 to the second VM 130, a remaining time of the timeslot 2 is allocated to the third VM 140 that is a sub task for this timeslot. On the other hand, if the second VM 130 doesn't voluntarily terminate during the timeslot 2, no remaining time of the timeslot 2 is allocated to the third VM 140. In such a case, the whole timeslot 2 is consumed only by the second VM 130.

Once the whole timeslot 2 has been consumed (in other words, once 100 μs has elapsed from the time of allocation of the timeslot 2 to the second VM 130), allocation of the timeslot 3 is then performed. The timeslot 3 is allocated to the third VM 140 that is a main task for this timeslot. Since the third VM 140 doesn't voluntarily terminate during the timeslot 3, the whole timeslot 3 is consumed only by the third VM 140.

Similarly, the timeslots 4-8 are allocated to their respective registered VMs. However, it should be noted that the timeslot 9 is allocated to the virtual device 150 (which will be described later), and the whole timeslot 9 is consumed only by the virtual device 150.

In addition, since no task has been registered with the timeslot 10 as shown in the timeslot management table of FIG. 9, allocation of the timeslot 10 is not to be performed (i.e. no task is to be performed) even when it is time to allocate the timeslot 10. Once 100 μs (a duration of the timeslot 10) has elapsed from the time of allocation of the timeslot 10, the timeslots 1-10 are allocated again form the timeslot 1 in ascending order.

### (5) Status of Execution for Interrupting Processes

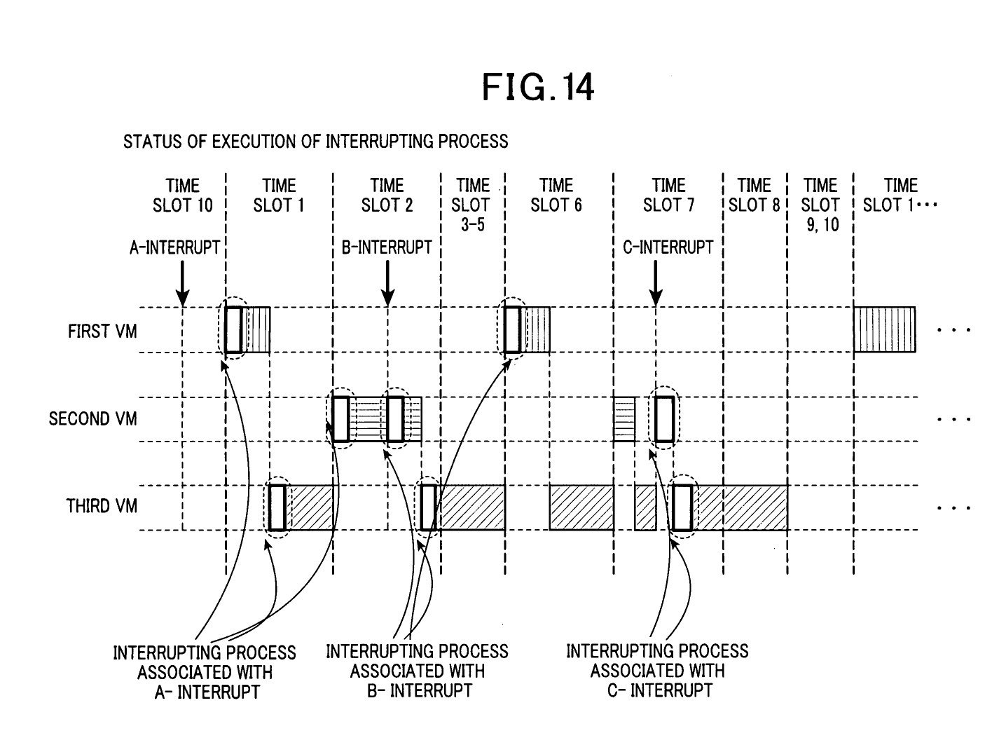

There will now be explained a status of execution for the interrupting processes with reference to FIG. 14. It is supposed that the scheduler 111 is configured to allocate timeslots in accordance with the timeslot management table as illustrated in FIG. 9. In the following, A-interrupt, B-interrupt and C-interrupt will be considered as an example. (In some embodiments there may be more interrupts.) It is supposed that the first to third VMs each implement interrupting processes respectively associated with the A-interrupt and the B-interrupt, and that the second and third VMs each implement an interrupting process associated with the C-interrupt.

It is supposed that the A-interrupt has occurred during the timeslot 10 with no registered VM. Once the timeslot 1 is then allocated to the first VM 120 that is a main task for this timeslot, the interrupting process associated with the A-interrupt is first performed in the first VM 120, and then some process other than this interrupting process is performed in this VM. Once the first VM is completed and then a remaining time of the timeslot 1 is allocated to the third VM 140 that is a sub task for this timeslot, the interrupting process associated with the A-interrupt is first performed in the third VM 140, and then some process other than this interrupting process is performed in this VM.

Once the timeslot 2 is then allocated to the second VM 130 that is a main task for this timeslot, the interrupting process associated with the A-interrupt is first performed in the second VM 130, and then some process other than this interrupting process is performed in this VM. All the interrupting processes associated with the A-interrupt are now completed, and then all the interrupt request flags associated with the A-interrupt are cleared (or reset).

Once the B-interrupt has occurred during the timeslot 2 allocated to the second VM 130 that is a main task for this timeslot, the interrupting process associated with the B-interrupt is immediately performed in the second VM 130. Once this interrupting process is completed, some process other than this interrupting process is performed in this VM. Once the second VM is completed, and then a remaining time of the timeslot 2 is allocated to the third VM 140 that is a sub task for this timeslot, the interrupting process associated with the B-interrupt is first performed in the third VM 140, and then some process other than this interrupting process is performed in this VM.

The timeslots 3-5 are then successively allocated to the third VM 140, respectively. It should be noted that the third VM 140 is associated with the B-interrupt. However, since the interrupting process associated with the B-interrupt in the third VM 140 has been performed during the timeslot 2, this interrupting process doesn't have to be performed again during the timeslots 3-5 in the third VM 140.

Once the timeslot 6 is then allocated to the first VM 120 that is a main task for this timeslot, the interrupting process associated with the B-interrupt is first performed in the first VM 120, and then some process other than this interrupting process is performed in this VM. All the interrupting processes associated with the B-interrupt are now completed, and then all the interrupt request flags associated with the B-interrupt are cleared (or reset). Once the first VM 120 is completed, a remaining time of the timeslot 6 is allocated to the third VM 140 that is a sub task for this timeslot.

The timeslot 7 is then allocated to the second VM 130 that is a main task for this timeslot. Once the second VM 130 is completed, a remaining time of the timeslot 7 is allocated to the third VM 140 that is a sub task for this timeslot. Once the C—interrupt has occurred during the remaining time of the timeslot 7 while the third VM 140 is being performed, a remaining time of the timeslot 7 is allocated to the second VM 130 in place of the third VM 140, and then the interrupting process associated with the C-interrupt is performed in the second VM 130. Once this interrupting process in the second VM 130 is completed, a remaining time of the timeslot 7 is allocated to the third VM 140 again, and then the interrupting process associated with the C-interrupt is performed in the third VM 140. All the interrupting processes associated with the C-interrupt are now completed, and then all the interrupt request flags associated with the C-interrupt are cleared (or reset). Once the interrupting process associated with the C-interrupt is completed in the third VM 140, some process other than this interrupting process is performed in this VM.

According to the timeslot management table in FIG. 9, the timeslot 8 is to be allocated to the third VM 140 that is a main task for this timeslot. However, the timeslots 9, 10 are to be allocated to none of the first to third VMs. The timeslot 1 is to be allocated again to the first VM 120.

### Other Embodiments

It is to be understood that the present invention is not to be limited to the specific embodiments disclosed and that modifications and other embodiments are intended to be included within the scope of the appended claims.

In the above embodiments, the four tasks given by the first to third VMs 120-140 and the virtual device 150 are registered with the scheduler 111. However, the number of such tasks is not limited to four. In addition, although the virtual device 150 is allocated to the timeslot 9 as a main task in the above embodiments, the virtual device 150 may be allocated to the timeslot as a sub task. Furthermore, in place of the above VMs, application programs which control external devices may be specific tasks to be allocated to the timeslots. Even such embodiments can provide similar advantages to the above embodiments.

In the above embodiments, the scheduler 111 is configured such that only one of the first to third VMs is registered as a sub task with one timeslot. However, a plurality of elements selected from the group comprising the first to third VMs and the virtual device 150 may be registered as sub tasks with one timeslot. Furthermore, the plurality of elements (e.g. a plurality of VMs) may be prioritized. Once the main task is completed, a remaining time of the timeslot allocated to the main task may preferentially be allocated to one of the plurality of VMs of a higher priority. Even such an embodiment also enables the CPU to perform both the real time task (s) and the non real time task (s) in parallel while preventing stagnation of a process to be performed by the non real time task.

### ADVANTAGES OF PRESENT INVENTION

In the consolidated ECU 10 as elaborated above, the CPU 11 is adapted to rewrite internal and external parameters into the external and internal parameters, respectively, with reference to a correspondence list previously set between the internal parameter and the external parameter. The internal parameter is a parameter that is to be used by a specific program such as VM 120, 130, 140, and the virtual device 150. The external parameter is a parameter that corresponds to the internal parameter and that is to be used by a program other than the specific program(s).

The above consolidated ECU 10 can provide the following advantages. For example, even if a destination address of the internal parameter changes after the whole specific program has been produced, the CPU 11 can rewrite the destination address into a corresponding external parameter indicating an appropriate destination address with reference to the correspondence list, without rewriting the specific program. In addition, even if a value of the internal parameter becomes invalid for the other programs due to a design change of the program configuration, the CPU 11 can rewrite the internal parameter into a corresponding external parameter indicating an appropriate value available for the other programs with reference to the correspondence list, and can output the corresponding external parameter.

In other words, further validation of validated components can be eliminated, even when a plurality of components such as application programs that have been implemented in respective microcomputers have to be implemented on one microcomputer, or even when a design of program configuration has been changed.

In some embodiments, the CPU 11 of the consolidated ECU 10 as elaborated above may be adapted to store (or buffer) a rewritten parameter by PAL 124, 134, 144, 154 in a predetermined storage area. In one particular embodiment, the CPU 11 may be adapted to store (or buffer) only a rewritten parameter (by PAL 124, 134, 144, 154) that belongs to the internal parameters in the predetermined storage area.

This makes it possible to acquire such a rewritten parameter whenever the specific program or the other programs need the rewritten parameter. Therefore, it is possible to relay the parameter in a preferable way, even if processing speeds of the specific program and the other programs differ from each other.

In addition, in the consolidated ECU 10 as elaborated above, the CPU 11 is adapted to receive via PAL 124, 134, 144, 154 a reset instruction indicating a reset range specifying which function(s) of the ECU 10 to be reset, and to reset the indicated reset range of functions, in a process of the specific program.

The consolidated ECU 10 as described above makes it possible to reset only a specified reset range. Since the consolidated ECU 10 is adapted to receive the reset instruction via PAL 124, 134, 144, 154, whether or not a resetting process should be performed can be determined for each reset class of reset instructions and for each specific program. Thus, the reset range may be specified by the reset instruction in detail.

In one embodiment of the consolidated ECU 10, the CPU 11 is adapted to receive a reset level (numerical information) corresponding to the reset range indicated by the reset instruction, and to identify the reset range corresponding to the received numerical information with reference to a database (see the table in FIG. 6A) prescribing a relation between reset levels (the numerical information) and reset ranges, and to reset the identified reset range of functions of the electronic control unit.

Since this enables the consolidated ECU 10 to utilize the reset level (numerical information) corresponding to the reset range, it is possible to make the reset range definite when changing the design of program configuration or when analyzing the programs.

In one embodiment of the consolidated ECU 10, the ECU 10 may further include timeslot allocating means for enabling the CPU 11 to perform a plurality of process units in parallel by allocating a timeslot to one of the plurality of process units according to predetermined timeslot allocating timing. The operation “allocating a timeslot to a process unit” means, for example, that execution right of the process unit during the timeslot is assigned to the CPU. The plurality of process units include a group of real time process units each required to respond to an external input in real time within a predetermined period and a group of non real time process units not required to meet such a requirement and each associated with one of the real time process units. The timeslot allocating means may include timeslot data indicating the predetermined timeslot allocating timing and may be adapted to allocate a timeslot to one of the real time process units based on the timeslot data at a first step.

In a preferred embodiment, the consolidated ECU 10 may include a basic program having been entitled to make the CPU 11 operate to have a function of the timeslot allocating means.

Again, the real time process unit is required to respond to an external input within a predetermined period. For instance, it is supposed that if there has been no external input until the end of the real time process unit, the real time process unit need not be continued until expiration of the allocated timeslot to the real time process unit. In other words, it is supposed that the real time process unit that has been allocated a timeslot may terminate without using up (or consuming) its whole allocated timeslot.

Therefore, in one embodiment of the consolidated ECU 10, the timeslot allocating means may further be adapted to if the one of the real time process units terminates before the timeslot allocated at the first step expires, allocate a remaining time of the timeslot to the non real time process unit associated with the real time process unit at a second step.

Because of this configuration, if the real time process unit terminates before it has used up (or consumed) its allocated timeslot, the non real time process unit associated with the real time process unit may be allocated (or assigned) a remaining time of the timeslot. Therefore, the above timeslot allocating means enables the CPU 11 to perform both the non real time process unit(s) and the real time process unit(s) in parallel while preventing stagnation of a process to be performed by the non real time process unit.

If the real time process unit terminates before it has used up (or consumed) its allocated timeslot, a remaining time of the timeslot may be allocated to the associated non real time process unit as follows.

The real time process unit may be associated with a plurality of non real time process units, and the plurality of non real time process units associated with the real time process unit may be prioritized. At the second step, a remaining time of the timeslot allocated to the real time process unit may preferentially be allocated to one of the plurality of non real time process units of a higher priority among the plurality of non real time process units.

This also enables the CPU 11 to perform both the non real time process unit(s) and the real time process unit(s) in parallel while preventing stagnation of a process to be performed by the non real time process unit.

As described above, one of the objects of the present invention is to consolidate a plurality of ECUs. To achieve this object, it is necessary to consolidate control programs of the respective ECUs and to produce a new program (which may be referred to as a basic program). Then, the process unit may be the following software program.

At least one of the process units may be a Virtual Machine Program (VM) that is a process unit based on a control program of a device other than a device in which the basic program is residing.

This enables the CPU to perform a plurality of VMs in parallel after a plurality of control programs residing in respective ECUs has been consolidated, while preventing stagnation of a process to be performed by the non real time VM.

Supposing that the process units are VMs, a VM may be configured to send an instruction to a peripheral device of the CPU that performs the basic program as follows.

The VM may be responsible to perform a process to control a peripheral device of a CPU of a device other than its own device that is a peripheral device used for the same purpose as a peripheral device of its own device that is a peripheral device of the CPU of the device in which the basic program is residing. The VM may also be configured to send an instruction to the peripheral device of its own device in a different manner from the peripheral device of the other device. The basic program may include: a third step of receiving from each VM an instruction directed to a peripheral device of its own device, in a similar manner to the peripheral device of the other device; and a fourth step of converting the instruction received at the third step into a form adapted to the peripheral device of its own device to control the same (the peripheral device of its own device).

This enables the VM to send instructions to the peripheral devices of the CPU of the consolidated ECU, in a manner adapted to the peripheral devices of CPUs of the pre-consolidation ECUs. Therefore, it is possible to generate the VMs, based on control programs of the pre-consolidation ECUs, without modifying portions of the control programs that send instructions to their peripheral devices. In other words, it is possible to minimize changes to the system when the control programs of the plurality of the ECUs are consolidated.

The VMs may be provided with data received from a peripheral device of the CPU as follows.

The basic program may further include: a fifth step of acquiring data received from the peripheral device of its own device; and a sixth step of providing the data acquired at the fifth step to the VM that has a process to control the peripheral device of an other device corresponding to the peripheral device of its own device, in a manner adapted to the peripheral device of the other device.

This enables the VM to receive data from the peripheral device of the CPU of the consolidated ECU, in a manner adapted to the peripheral device of the CPU of the pre-consolidation ECU. Therefore, it is possible to produce the VMs, based on control programs of the pre-consolidation ECUs, without modifying portions of the control programs of the pre-consolidation ECUs that receive instructions from their peripheral devices. In other words, it is possible to minimize changes to the system when the control programs of the plurality of the ECUs are consolidated.

In addition, a control program of a pre-consolidation ECU may have an interrupting process. For instance, when a process unit is a VM based on such a control program, the basic program may further include the following step.

There may be an interrupt-enabled process unit having an interrupting process associated with a predetermined interrupt. The basic program may further include a seventh step of: if a predetermined interrupt occurs during a timeslot or a remaining time of the timeslot allocated to the interrupt-enabled process unit associated with the predetermined interrupt, performing the interrupting process associated with the predetermined interrupt.

This enables implementation of the interrupting process of the interrupt-enabled process unit to be ensured. As an example, even when such an interrupting process is used for a control program of a pre-consolidation ECU, the VM for which this interrupting process is used may be a process unit. Therefore, it is possible to minimize changes to the system when control programs of a plurality of ECUs are consolidated.

The interrupting process should be performed as soon as possible after the interrupt request has been issued.

Accordingly, the basic program may further include an eighth step of: once a timeslot or a remaining time of the timeslot is allocated to an interrupt-enabled process unit associated with a predetermined interrupt after occurrence of the predetermined interrupt, performing the interrupting process associated with the predetermined interrupt.

This enables the interrupting process associated with the interrupt request that has occurred prior to the timeslot allocation to be performed immediately after the timeslot allocation.

In some embodiments, the interrupting process may be performed as follows.

It may be supposed that a real time process unit allocated a timeslot at the first step is a main process unit that is interrupt-enabled and that a non real time process unit allocated a remaining time of the timeslot at the second step is a sub process unit.

Then, the basic program may further include a ninth step of: if a predetermined interrupt directed to the main process unit occurs during a remaining time of the timeslot allocated to the sub process unit at the second step, performing an interrupting process associated with the predetermined interrupt in the main process unit, prior to the seventh step.

In this way, in cases where an interrupt request directed to the main process unit has occurred during the remaining time of the timeslot allocated to the associated sub process unit, this enables the main process unit to be preferentially performed. Therefore, the main process unit may be preferentially performed to the associated sub process unit, which ensures that the real time process unit can respond (to an external input) in real time within a predetermined period.

What is claimed is:

1. A relay program for enabling a computer to relay a parameter inputted/outputted by a first program when the first program is performed between the first program and a second program other than the first program, the first program being implemented and specified as a specific program in a consolidated ECU (electronic control unit) integrally produced by a plurality of ECUs, the second program being implemented in the consolidated ECU, the relay program stored in a memory in advance and readable by the computer when the computer is activated, and the relay program enabling the computer to have functions of:
acquisition means for acquiring either an internal parameter or an external parameter, the internal parameter being a parameter that is to be used by the first program, the external parameter being a parameter that corresponds to the internal parameter and that is to be used by the second program; and
rewriting means for rewriting the internal and external parameters into the external and internal parameters, respectively, with reference to a correspondence list previously set between the internal parameter and the external parameter.

2. The relay program of claim 1, enabling the computer to have a further function of storage means for storing a rewritten parameter by the rewriting means in a predetermined storage area.

3. The relay program of claim 2, wherein the storage means is adapted to store a rewritten parameter by the rewriting means that is the internal parameter.

4. An electronic control unit comprising:
a CPU; and
relay means for enabling the CPU to relay a parameter inputted/outputted by a first program when the first program is performed between the first program and a second program other than the first program, the first program being implemented and specified as a specific program in the electronic control unit, the second program being implemented in the electronic control unit, the relay means is adapted to:
acquiring either an internal parameter or an external parameter, the internal parameter being a parameter that is to be used by the first program, the external parameter being a parameter that corresponds to the internal parameter and that is to be used by the second program; and
rewrite the internal and external parameters into the external and internal parameters, respectively, with reference to a correspondence list previously set between the internal parameter and the external parameter.

5. The electronic control unit of claim 4, further comprising:
reset instruction receiving means for receiving a reset instruction via the relay means, the reset instruction indicating a reset range specifying which function or functions of the electronic control unit to be reset as a process of the first program; and
resetting means for resetting the indicated reset range of functions of the electronic control unit.

6. The electronic control unit of claim 5, wherein the reset instruction receiving means is adapted to receive numerical information corresponding to the reset range indicated by the reset instruction, and the resetting means is adapted to identify the reset range corresponding to the received numerical information with reference to a database prescribing a correspondence relation between the reset range and the numerical information, and to reset the identified reset range of functions of the electronic control unit.

7. The electronic control unit of claim 4, further comprising timeslot allocating means for enabling the CPU to perform a plurality of process units by allocating a timeslot to one of the plurality of process units according to predetermined timeslot allocating timing, wherein the plurality of process units include a group of real time process units each required to respond to an external input in real time within a predetermined period and a group of non real time process units not required to meet such a requirement and each associated with one of the real time process units, and wherein
the timeslot allocating means comprises timeslot data indicating the predetermined timeslot allocating timing, and
the timeslot allocating means is adapted to allocate the timeslot to one of the real time process units based on the timeslot data.

8. The electronic control unit of claim 7, wherein the timeslot allocating means is further adapted to if the one of the real time process units terminates before the allocated timeslot to the one of the real time process units expires, allocate a remaining time of the allocated timeslot to the non real time process unit associated with the one of the real time process units.

9. The electronic control unit of claim 4, wherein the relay means is further adapted to store a rewritten parameter by the relay means in a predetermined storage area.

10. The electronic control unit of claim 9, wherein the relay means is further adapted to store a rewritten parameter by the relay means that is the internal parameter in the predetermined storage area.
